(19) United States
(12) Patent Application Publication
(10) Pub. No.: US 2013/0075625 A1
(43) Pub. Date: Mar. 28, 2013

(54) TARGET SUPPLY UNIT AND EXTREME ULTRAVIOLET LIGHT GENERATION APPARATUS

(71) Applicants: Takayuki YABU, Hiratsuka-shi (JP); Yoshifumi UENO, Hiratsuka-shi (JP); Junichi FUJIMOTO, Hiratsuka-shi (JP); Yukio WATANABE, Hiratsuka-shi (JP); Toshihiro NISHISAKA, Hiratsuka-shi (JP)

(72) Inventors: Takayuki YABU, Hiratsuka-shi (JP); Yoshifumi UENO, Hiratsuka-shi (JP); Junichi FUJIMOTO, Hiratsuka-shi (JP); Yukio WATANABE, Hiratsuka-shi (JP); Toshihiro NISHISAKA, Hiratsuka-shi (JP)

(73) Assignee: GIGAPHOTON INC.

(21) Appl. No.: 13/553,621

(22) Filed: Jul. 19, 2012

(30) Foreign Application Priority Data
Sep. 27, 2011 (JP) 2011-210696

(51) Int. Cl. F23D 11/32; G21K 5/04

(52) U.S. Cl. 250/428; 239/690

(57) ABSTRACT

A target supply unit includes a nozzle through which a target material is outputted, and a first electrically conductive member having a first opening formed therein and positioned to face the nozzle in a direction into which the target material is outputted through the nozzle. The first electrically conductive member is positioned so that the first opening is located below the nozzle in a gravitational direction. The target supply unit includes a voltage generator which applies a voltage between the target material and the first electrically conductive member.

### CROSS-REFERENCE TO RELATED APPLICATION

The present application claims priority from Japanese Patent Application No. 2011-210696 filed Sep. 27, 2011.

### BACKGROUND

1. Technical Field

This disclosure relates to a target supply unit and an extreme ultraviolet (EUV) light generation apparatus.

2. Related Art

In recent years, semiconductor production processes have become capable of producing semiconductor devices with increasingly fine feature sizes, as photolithography has been making rapid progress toward finer fabrication. In the next generation of semiconductor production processes, microfabrication with feature sizes at 60 nm to 45 nm, and further, microfabrication with feature sizes of 32 nm or less will be required. In order to meet the demand for microfabrication with feature sizes of 32 nm or less, for example, an exposure apparatus is needed in which a system for generating EUV light at a wavelength of approximately 13 nm is combined with a reduced projection reflective optical system.

Three kinds of systems for generating EUV light are known in general, which include a Laser Produced Plasma (LPP) type system in which plasma is generated by irradiating a target material with a laser beam, a Discharge Produced Plasma (DPP) type system in which plasma is generated by electric discharge, and a Synchrotron Radiation (SR) type system in which orbital radiation is used to generate plasma.

### SUMMARY

A target supply unit according to one aspect of this disclosure may include: a nozzle through which a target material is outputted; a first electrically conductive member having a first opening formed therein and positioned to face the nozzle in a direction into which the target material is outputted through the nozzle, the first electrically conductive member being positioned so that the first opening is located below the nozzle in a gravitational direction; and a voltage generator configured to apply a voltage between the target material and the first electrically conductive member.

An apparatus for generating extreme ultraviolet light according to another aspect of this disclosure may include: a chamber; the above-described target supply unit; a focusing optical system configured to direct an externally-applied pulse laser beam to a predetermined position inside the chamber; and a collector mirror configured to collect and output and outputting the extreme ultraviolet light generated inside the chamber.

### BRIEF DESCRIPTION OF THE DRAWINGS

Hereinafter, selected embodiments of this disclosure will be described with reference to the accompanying drawings.

FIG. 1A is a diagram for discussing a cause for a phenomenon where a target material projecting through an outlet of a nozzle grows excessively large.

FIG. 1B is a diagram for discussing another cause for a phenomenon where a target material projecting through an outlet of a nozzle grows excessively large.

FIG. 2 schematically illustrates the configuration of an exemplary EUV light generation apparatus.

FIG. 3 schematically illustrates an example of the configuration of a target supply unit according to a first embodiment and the peripheral components thereof.

FIG. 4 is a fragmentary enlarged view illustrating a leading end portion of the target supply unit according to the first embodiment.

FIG. 5 is a sectional view of the target supply unit shown in FIG. 4, taken along V-V plane.

FIG. 6 shows a variation of a shape of an opening.

FIG. 7A is a diagram for discussing a process through which a droplet of a target material is generated by the target supply unit of the first embodiment.

FIG. 7B is another diagram for discussing the process through which the droplet of the target material is generated by the target supply unit of the first embodiment.

FIG. 8 illustrates an example of the configuration of a target supply unit according to a modification of the first embodiment.

FIG. 9 is a fragmentary enlarged view illustrating a leading end portion of the target supply unit according to the modification of the first embodiment.

FIG. 10 shows the leading end portion shown in FIG. 9 in a direction of an arrow A.

FIG. 11 schematically illustrates an example of the configuration of a target supply unit according to a second embodiment.

FIG. 12 is a fragmentary enlarged view illustrating a leading end portion of the target supply unit according to the second embodiment.

FIG. 13 is a sectional view of the target supply unit shown in FIG. 12, taken along XIII-XIII plane.

FIG. 14 is a sectional view of the target supply unit shown in FIG. 12, taken along XIV-XIV plane.

FIG. 15A is a diagram for discussing a process through which a droplet of a target material is generated and accelerated by the target supply unit of the second embodiment.

FIG. 15B is another diagram for discussing the process through which the droplet of the target material is generated and accelerated by the target supply unit of the second embodiment.

### DETAILED DESCRIPTION

Hereinafter, selected embodiments of this disclosure will be described in detail with reference to the accompanying drawings. The embodiments to be described below are merely illustrative in nature and do not limit the scope of this disclosure. Further, the configuration(s) and operation(s) described in each embodiment are not all essential in implementing this disclosure. Note that like elements are referenced by like reference numerals and characters, and duplicate descriptions thereof will be omitted herein. The embodiments will be described following the table of contents below.
1. Overview
2. Overview of EUV Light Generation System
2.1 Configuration
2.2 Operation
3. Target Supply Unit: First Embodiment
3.1 Configuration
3.2 Operation
3.3 Modifications
3.3.1 First Modification
3.3.2 Second Modification
4. Target Supply Unit: Second Embodiment
4.1 Configuration
4.2 Operation

### 1. Overview

In an LPP-type EUV light generation apparatus, a target supply unit may be configured to output a target material, such as tin, in the form of a droplet into a chamber through a nozzle. Inside the chamber, a droplet of the target material (hereinafter, a droplet of the target material may be referred to simply as “a droplet” when appropriate) may be irradiated with a laser beam, and turned into plasma. EUV light may be emitted from the target material that has been turned into plasma. The emitted EUV light may be focused at a predetermined position by a collector mirror provided inside the chamber, and outputted to an exposure apparatus. Here, the EUV light generation apparatus may, in some cases, be installed so as to be inclined with respect to the gravitational direction so that the EUV light is outputted to the exposure apparatus at an angle in accordance with the requirements of the exposure apparatus.

When the EUV light generation apparatus is installed so as to be inclined with respect to the gravitational direction, the target supply unit may be positioned such that a direction into which the target material is outputted is inclined with respect to the gravitational direction. In that case, the target supply unit may be provided with an electrostatic pull-out mechanism configured to pull out and direct the target material toward the predetermined position inside the chamber by electrostatic force. The electrostatic pull-out mechanism may, for example, include a planar electrically conductive member, serving as an electrode, provided so as to face the nozzle thereof, and the electrode may have a through-hole formed therein to allow the target material to pass therethrough.

In the above-described configuration, there may be a case where the target material projecting from the nozzle outlet grows excessively large and the projecting target material drops in the gravitational direction. This may be because, of the forces that act on the projecting target material, the gravitational force dominates the electrostatic force caused by the electrostatic pull-out mechanism. When the EUV light generation apparatus is designed such that the direction in which the target material is outputted from the target supply unit is inclined with respect to the gravitational direction, the target material may come into contact with the electrode provided so as to face the nozzle and adhere to the electrode. When the target material adheres to the electrode of the electrostatic pull-out mechanism, an electric field that causes the electrostatic force may be disturbed. Accordingly, the target material may not be outputted stably.

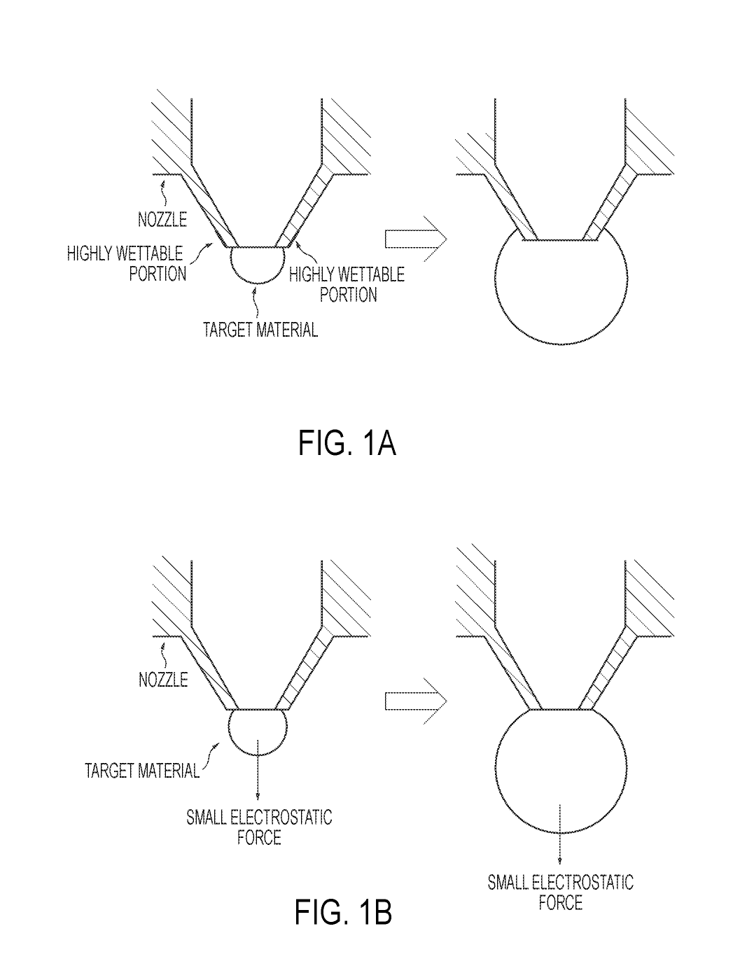

Causes for a phenomenon where the target material projecting through an outlet of a nozzle grows excessively large will now be discussed with reference to FIGS. 1A and 1B. First, as shown in FIG. 1A, when a tip portion of the nozzle is highly wettable with the target material, the surface tension that acts on the projecting target material may be increased. Accordingly, the projecting target material may not be separated by the electrostatic force, and thus the projecting target material may grow excessively large. Secondly, as shown in FIG. 1B, when the electrostatic force caused by the electrostatic pull-out mechanism falls below a predetermined level, the electrostatic force that acts on the projecting target material may become smaller than the surface tension that acts on the projecting target material. In this case, the projecting target material may not be separated by the electrostatic force, and the projecting target material may grow excessively large. In either case, the projecting target material may grow excessively large, and the gravitational force that acts on the projecting target material becomes dominant. Thus, the target material may drop in the gravitational direction.

Accordingly, disclosed in this specification is a target supply unit configured to prevent the target material from adhering onto an electrically conductive member even when an EUV light generation apparatus is installed so as to be inclined with respect to the gravitational direction.

### 2. Overview of EUV Light Generation System

### 2.1 Configuration

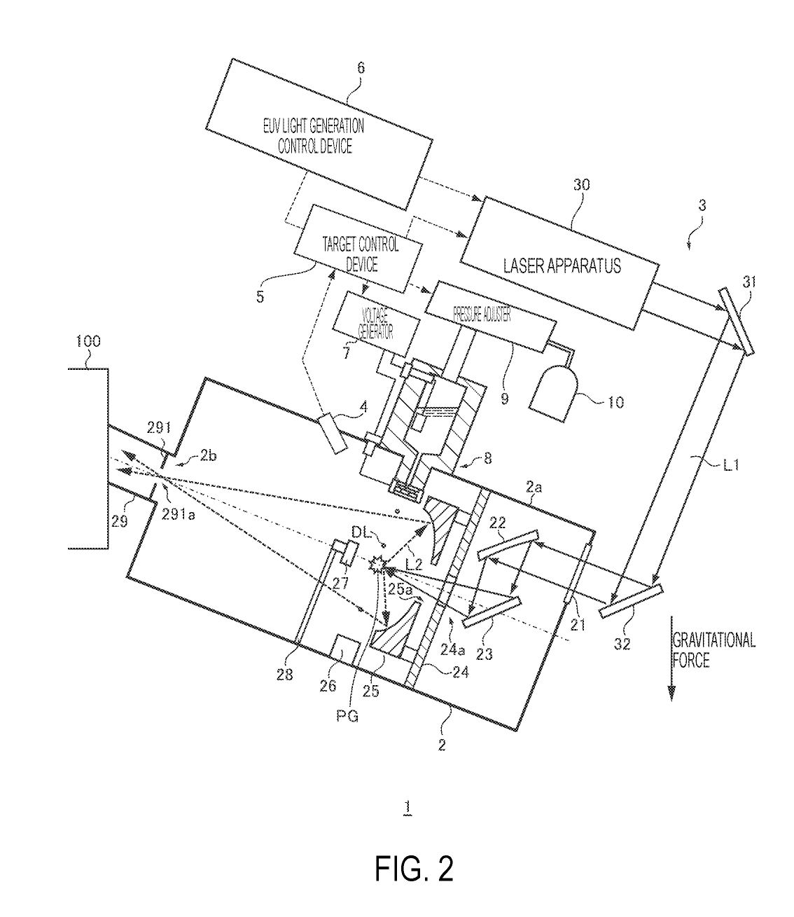

FIG. 2 schematically illustrates the configuration of an exemplary LPP-type EUV light generation apparatus. As shown in FIG. 2, an EUV light generation apparatus 1 may include a laser apparatus 30, a focusing optical system 3, a chamber 2, a target supply unit 8, and a connection part 29 interposed between the chamber 2 and an exposure apparatus 100. The EUV light generation apparatus 1 may be installed so as to be inclined with respect to the gravitational direction.

The target supply unit 8 may be configured to output a target material in the form of droplets DL toward a plasma generation region PG inside the chamber 2. Here, a designed path of a droplet DL from the target supply unit 8 to the plasma generation region PG may be inclined with respect to the gravitational direction. The droplet DL may, for example, be 20 to 30 μm in diameter. The plasma generation region PG may be a region in which the droplet DL is irradiated with a pulse laser beam L1 and turned into plasma and EUV light L2 is emitted from the plasma. The target supply unit 8 may include a tank in which the target material is stored and a nozzle through which the target material inside the tank is outputted. The target supply unit 8 may, for example, be mounted on a wall 2a of the chamber 2. The target material to be supplied by the target supply unit 8 may include, but is not limited to, tin, terbium, gadolinium, lithium, xenon, or any combination thereof.

The EUV light generation apparatus 1 may further include a voltage generator 7, a pressure adjuster 9, and a gas storage 10. The gas storage 10 may store an inert gas, such as an argon gas, and may be connected to the pressure adjuster 9. The pressure adjuster 9 may be configured to apply a predetermined pressure on the target material inside the tank by the inert gas supplied from the gas storage 10. Being pressurized by the inert gas, the target material inside the tank may project through the nozzle.

The target supply unit 8 may further include an electrostatic pull-out mechanism which utilizes the voltage generator 7. The voltage generator 7 may be configured to apply a voltage between the target material and an electrically conductive member of the electrostatic pull-out mechanism in order to pull the target material out through the nozzle of the target supply unit 8 and direct a pulled-out droplet DL along a desired path by the electrostatic force. The details of the target supply unit 8 and the electrostatic pull-out mechanism will be given later.

The laser apparatus 30 may be configured to output a pulse laser beam L1 to strike the target material and turn the target material into plasma. The laser apparatus 30 may, for example, be a CO₂ pulse laser apparatus. The specification of the laser apparatus 30 may, for example, be as follows: the wavelength of 10.6 μm, the output power of 20 kW, the pulse repetition rate of 30 to 100 kHz, and the pulse duration of 20 nsec. However, this disclosure is not limited to this specification. The laser apparatus 30 may include, aside from the CO₂ pulse laser apparatus, an additional laser apparatus.

The focusing optical system 3 may be arranged to guide the pulse laser beam L1 from the laser apparatus 30 toward the plasma generation region PG. The focusing optical system 3 may include high-reflection mirrors 31 and 32, an off-axis paraboloidal mirror 22, and a flat mirror 23. A part of the focusing optical system 3 (the off-axis paraboloidal mirror 22 and the flat mirror 23 in the configuration shown in FIG. 2) may be arranged inside the chamber 2. At least one window 21 may be provided on the wall 2a of the chamber 2, and the pulse laser beam L1 may be transmitted through the window 21 to enter the chamber 2.

An exhaust pump (not separately shown) may, for example, be connected to the chamber 2, and the interior of the chamber 2 may be kept at a low pressure (e.g., around 10⁻³ Pa) or in vacuum by the exhaust pump. A plate 24 may be provided inside the chamber 2 to support an EUV collector mirror 25. The plate 24 may have a through-hole 24a formed therein, and the pulse laser beam L1 introduced into the chamber 2 through the window 21 may travel through the through-hole 24a.

The EUV collector mirror 25 may have a through-hole 25a formed at the center thereof, and the pulse laser beam L1 that has passed through the through-hole 24a in the plate may travel through the through-hole 25a in the EUV collector mirror toward the plasma generation region PG. The EUV collector mirror 25 may have a multi-layered reflective film formed on a surface thereof, the reflective film including, for example, a molybdenum layer and a silicon layer being laminated alternately. The EUV collector mirror 25 may have a first focus and a second focus, may preferably be positioned such that the first focus lies in the plasma generation region PG and the second focus lies in an intermediate focus (IF) region. The reflective surface of the EUV collector mirror 25 may, for example, be spheroidal in shape. However, the shape of the reflective surface of the EUV collector mirror 25 is not limited thereto as long as the reflective surface has desired first and second focuses.

A target collector 26 may be provided inside the chamber 2 at a location that faces the nozzle of the target supply unit 8 in order to collect the droplets DL. Further, a beam dump 27 may be provided inside the chamber 2 to absorb the pulse laser beam L1. Providing the beam dump 27 to absorb the pulse laser beam L1 may help to prevent the pulse laser beam L1 from entering the connection part 29 directly or indirectly having been reflected by the wall 2a of the chamber 2. The beam dump 27 may be fixed at a predetermined position through a support 28 attached to the wall 2a of the chamber 2.

The connection part 29 may be provided to allow the interior of the chamber 2 and the interior of the exposure apparatus 100 to be in communication with each other. The connection part 29 may be in communication with the chamber 2 through a through-hole 2b formed in the wall 2a of the chamber 2. A wall 291 having an aperture 291a may be provided inside the connection part 29. The wall 291 may be positioned such that the second focus of the EUV collector mirror 25 lies in the aperture 291a formed in the wall 291.

The EUV light generation apparatus 1 may further include a target sensor 4, a target control device 5, and an EUV light generation control device 6. The EUV light generation control device 6 may include a microcontroller as a primary component, and be configured to control the overall operation of the EUV light generation apparatus 1. The EUV light generation control device 6 may, for example, be communicably connected to a controller (not shown) of the exposure apparatus 100. Upon receiving an output request of EUV light from the controller of the exposure apparatus 100, the EUV light generation control device 6 may control the EUV light generation apparatus 1 such that the EUV light in accordance with the output request is outputted to the exposure apparatus 100.

The target control device 5 may be configured to accept a detection signal from the target sensor 4. The target sensor 4 may be configured to detect the droplet DL outputted from the target supply unit 8. Here, the target sensor 4 may be configured to detect at least one of the presence, the trajectory, the speed, and the position of the droplet DL in a predetermined region. The target sensor 4 may include an imaging device (e.g., an image sensor) to detect the droplet DL.

The target control device 5 may be connected electrically to the laser apparatus 30, the voltage generator 7, the pressure adjuster 9, and the EUV light generation control device 6. The target control device 5 may be configured to control the pressure adjuster 9 in accordance with a supply instruction signal from the EUV light generation control device 6. The pressure adjuster 9 may be configured to control the pressure of the inert gas such that the pressure applied to the target material inside the tank of the target supply unit 8 is adjusted to a pressure appropriate for causing the target material to project through the nozzle.

The target control device 5 may be configured to control an oscillation timing of the laser apparatus 30 based on the detection signal from the target sensor 4 such that the droplet DL is irradiated with the pulse laser beam L1 at a timing at which the droplet DL reaches the plasma generation region PG. For example, the target control device 5 may be configured to output a trigger signal to the laser apparatus 30 to cause the laser apparatus 30 to oscillate.

### 2.2 Operation

With continued reference to FIG. 2, the pulse laser beam L1 outputted from the laser apparatus 30 may be reflected by the high-reflection mirrors 31 and 32, and enter the chamber 2 through the window 21. The pulse laser beam L1 may travel inside the chamber 2 along at least one beam path, be reflected by the off-axis paraboloidal mirror 22 and the flat mirror 23, and strike at least one droplet DL.

The target supply unit 8 may be configured to output the target material in the form of droplets DL toward the plasma generation region PG. When the target supply unit 8 is operating properly, even if the EUV light generation apparatus 1 is inclined with respect to the gravitational direction, the droplet DL may be directed toward the plasma generation region PG by the electrostatic pull-out mechanism of the target supply unit 8. The droplet DL may be irradiated with at least one pulse included in the pulse laser beam L1. The droplet DL that has been irradiated with the pulse laser beam L1 may be turned into plasma, and the EUV light L2 may be emitted from the plasma. The EUV light L2 may include light at a wavelength of, for example, 13.5 nm. The EUV light L2 may be selectively reflected by the EUV collector mirror 25. The EUV light L2 reflected by the EUV collector mirror 25 may be focused in the intermediate focus region.

The target sensor 4 may detect the droplet DL outputted from the target supply unit 8, and, upon obtaining a detection result, send the detection result to the target control device 5. The target control device 5 may control the laser apparatus 30 based on the detection result from the target sensor 4 so that the droplet DL is irradiated with the pulse laser beam L1 in the plasma generation region PG. The target control device 5 may control an output timing, a travel direction, and so forth of the pulse laser beam L1.

### 3. Target Supply Unit: First Embodiment

### 3.1 Configuration

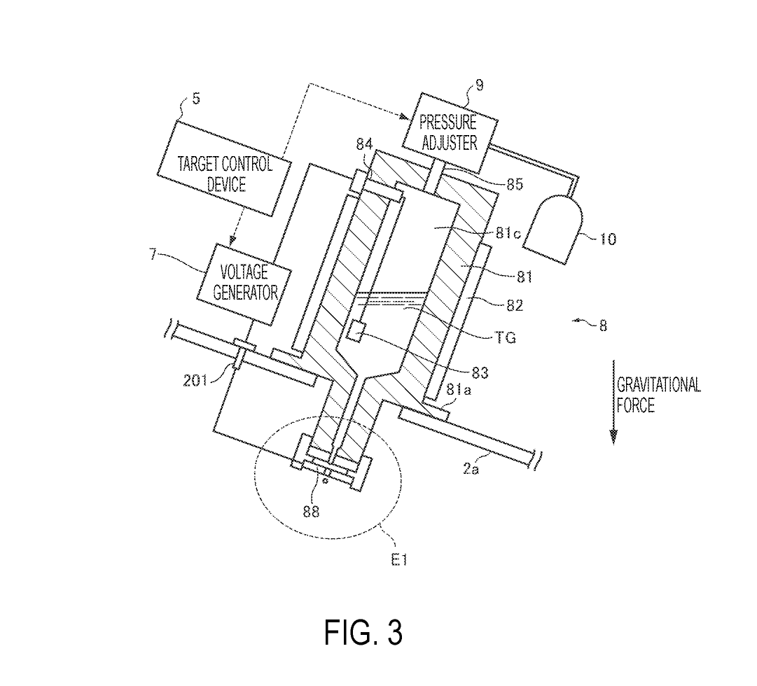

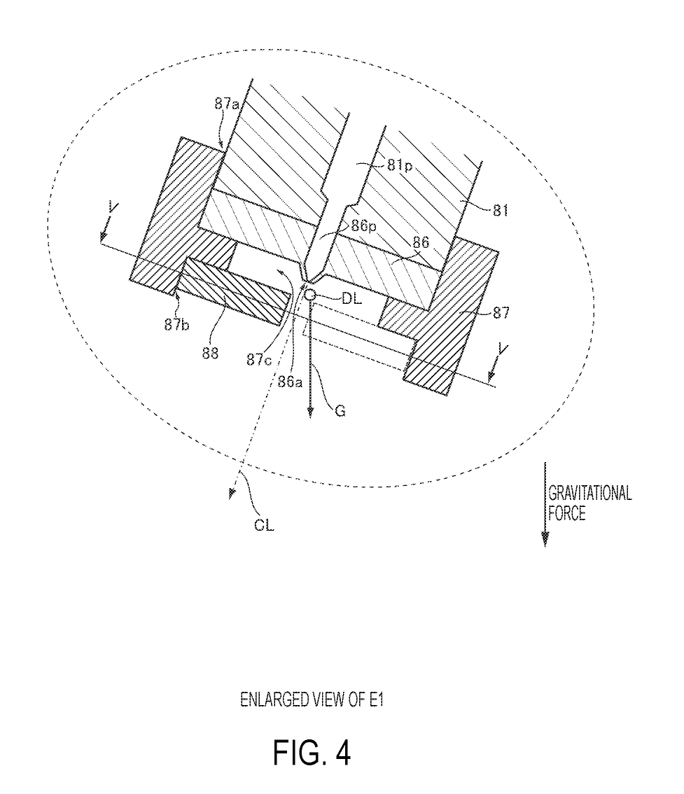

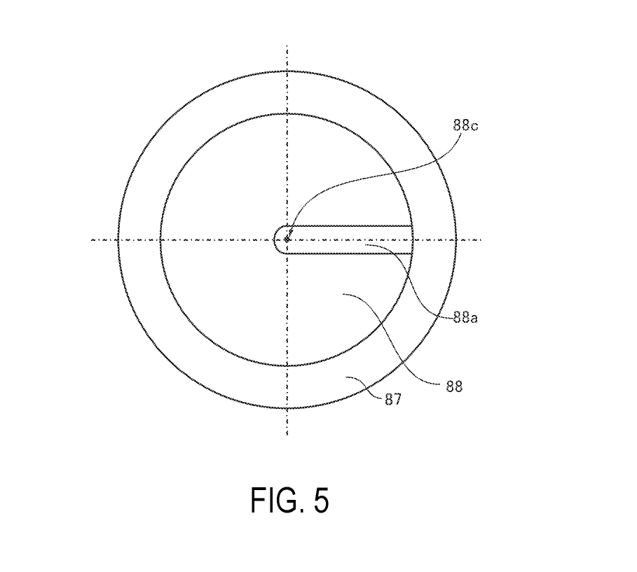

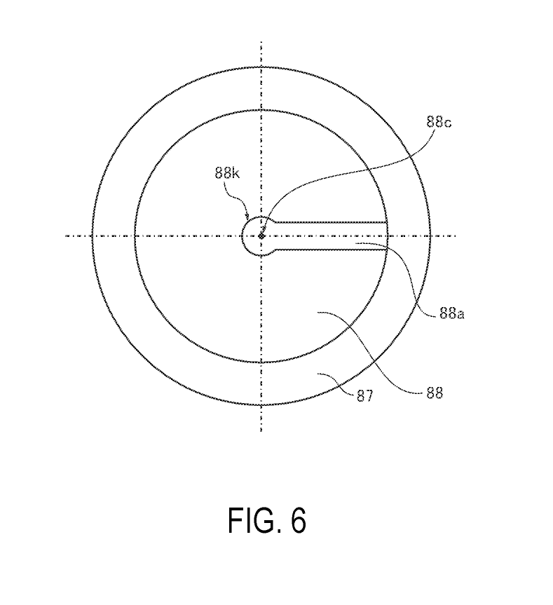

Hereinafter, an example of the configuration of a target supply unit according to a first embodiment will be described with reference to FIGS. 3 through 6. FIG. 3 schematically illustrates an example of the configuration of the target supply unit according to the first embodiment and the peripheral components thereof. FIG. 4 is a fragmentary enlarged view illustrating a leading end portion of the target supply unit shown in FIG. 3. FIG. 5 is a sectional view of the target supply unit shown in FIG. 4, taken along V-V plane. FIG. 6 shows a variation of a shape of an opening.

As shown in FIG. 3, the target supply unit 8 may include a tank 81, a heater 82, an electrode 83, an introduction terminal 84, and a pipe 85. The target supply unit 8 may be mounted on the wall 2a of the chamber 2 (see FIG. 2) such that a leading end portion E1 of the target supply unit 8 projects into the chamber 2. In the configuration shown in FIGS. 3 and 4, the tank 81 may preferably be formed of an electrically non-conductive material. The tank 81 may include a flange 81a, a storage 81c in which a target material TG is stored, and a communication channel 81p to allow the storage 81c and a nozzle unit 86 to be in communication with each other. The flange 81a may be fixed to the outer surface of the wall 2a by a fixing unit (not shown). The fixing unit is not particularly limited and may, for example, be a tightening unit including a bolt and a nut, a welding unit, and the like.

The heater 82 may be provided around the tank 81, and the target material TG inside the storage 81c may be retained in a molten state by the heater 82. When the target material TG is tin, the heater 82 may be configured to heat the storage 81c to a temperature higher than the melting point of tin, such as 300° C. The type of the heater 82 is not particularly limited, and may, for example, be a ceramic heater.

As shown in FIGS. 4 and 5, a substantially cylindrical electrical insulator 87 may be provided at the leading end portion E1 of the target supply unit 8. A recess 87a may be formed in one of the flat surfaces of the electrical insulator 87, and recesses 87b and 87c each having a differing opening cross-section area may be formed continuously in the other flat surface of the electrical insulator 87. The nozzle unit 62 and an end of the tank 81 may be fitted sequentially in the recess 87a formed in the electrical insulator 87. An electrode 88, serving as a first electrically conductive member, may be fitted in the recess 87b formed in the electrical insulator 87. With this arrangement, the nozzle unit 86 and the electrode 88 may face each other with a space secured therebetween.

The electrode 88 may include an electrically conductive material, such as molybdenum, and may be coated on its surface with an electrically non-conductive material, such as a ceramic. The center of the nozzle unit 86 may project into the recess 87c formed in the electrical insulator 87. An outlet 86a may be formed at substantially the center of the conically-projecting portion of the nozzle unit 86, and the target material TG may be outputted through the outlet 86a. The tip of the outlet 86a may be formed of an electrically non-conductive material so that an electric field is enhanced at the target material TG by the electrostatic pull-out mechanism of the target supply unit 8. Here, members, such as the tank 81 and the nozzle unit 86, of the target supply unit 8 which may come into contact with the target material TG may preferably be formed of a material that is resistant to corrosion by the target material TG. Such a member may be formed, for example, of a ceramic when the target material TG is tin.

Referring back to FIG. 3, the electrode 83 may be provided so as to be in contact with the target material TG stored inside the storage 81c. Wiring connected to the electrode 83 may be connected to the voltage generator 7 through the introduction terminal 84 provided so as to penetrate the tank 81. Thus, the electrode 83 and the voltage generator 7 may be connected to each other electrically. Wiring connected to the electrode 88 may be connected to the voltage generator 7 through an introduction terminal 201 provided so as to penetrate the wall 2a in a state where electrical insulation between the wiring and the wall 2a is secured. Thus, the electrode 88 and the voltage generator 7 may be electrically connected to each other.

As shown in FIGS. 4 and 5, the electrode 88 may be substantially disc-shaped, and be positioned along a plane perpendicular to a moving path of a droplet DL from the outlet 86a to the plasma generation region PG. The electrode 88 may have an opening 88a, serving as a first opening, formed therein. The electrode 88 may be positioned such that a center 88c of the electrode 88 lies on an axis CL of the conical portion of the nozzle unit 86.

As one example of the opening 88a, the opening 88a that extends linearly from the center 88c toward the periphery of the electrode 88 may be formed, as shown in FIG. 5. As another example of the opening 88a, a substantially circular opening 88k having a predetermined radius from the center 88c may further be provided, as shown in FIG. 6. In the example shown in FIG. 6, the radius of the opening 88k may be determined such that the droplet DL does not come into contact with the electrode 88 even when an output direction of the droplet DL varies.

### 3.2 Operation

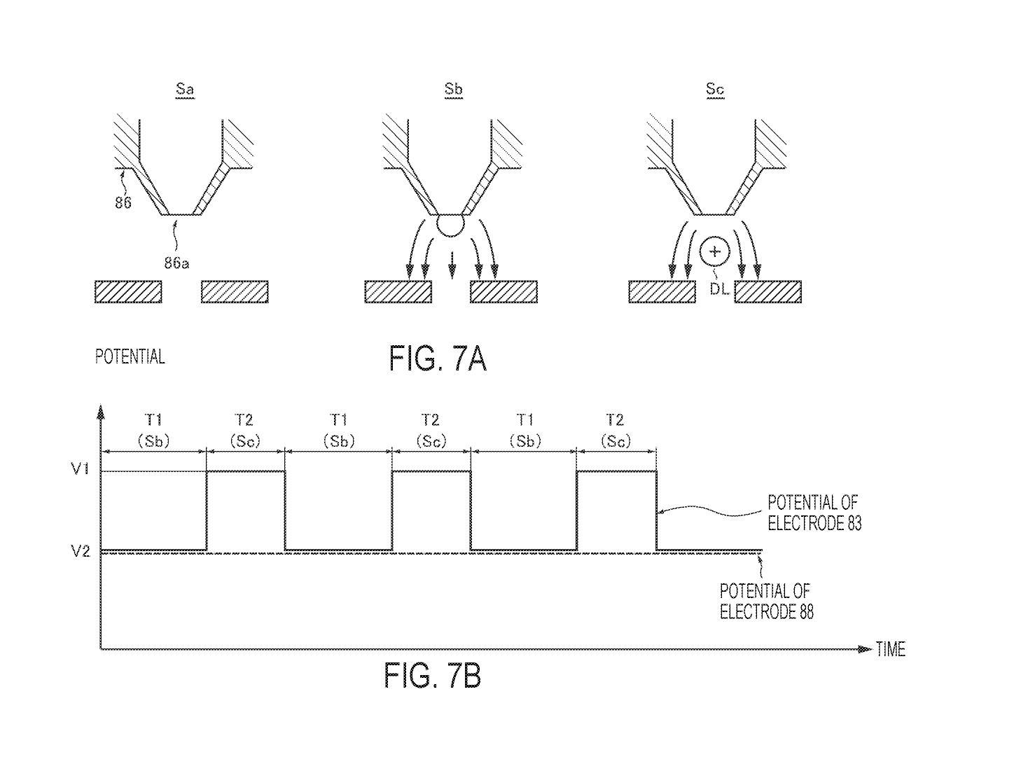

The operation of the target supply unit 8 will now be described with reference to FIGS. 3 through 7B. FIGS. 7A and 7B are diagrams for discussing the process through which a droplet of the target material is generated. In the configuration shown in FIGS. 3 through 6, the target control device 5 may be configured to send control signals respectively to the voltage generator 7 and the pressure adjuster 9 to define operation timings of the voltage generator 7 and the pressure adjuster 9.

Before the target supply unit 8 is put in operation, the communication path 81p formed in the tank 81 and a communication path 86p formed in the nozzle unit 86 may be filled with the target material in a molten state, such as state Sa in FIG. 7A. When the target supply unit 8 is put in operation, the pressure adjuster 9 may first adjust a pressure of the inert gas supplied from the gas storage 10 to a predetermined pressure based on a control signal from the target control device 5. As a result, the target material TG inside the tank 81 may be pressurized, and the target material TG may project through the outlet 86a formed in the nozzle unit 86, such as state Sb in FIG. 7A. In this state, the pressure on the target material TG by the inert gas, the gravitational force acting on the target material TG, and the surface tension acting on the projecting target material TG may be in balance.

Subsequently, the voltage generator 7 may intermittently apply a predetermined voltage between the electrode 83 and the electrode 88 based on a control signal from the target control device 5. Here, as one example, when a potential applied to the electrode 88 is V2, a potential applied to the electrode 83 may be varied as V2→V1→V2→V1→ . . . (V1>V2), as shown in FIG. 7B. That is, the voltage generator 7 may intermittently apply a voltage (V1-V2) between the electrode 83 and the electrode 88. The applied voltage (V1-V2) may, for example, be around 20 kV. Since an electric field generated by applying the aforementioned voltage may be enhanced at the target material projecting through the outlet 86a as in the state Sb in FIG. 7A, the target material projecting through the outlet 86a may be separated from the outlet 86a and be outputted as a droplet DL by the electrostatic force in the electric field, such as state Sc in FIG. 7A. At this point, the droplet DL may be positively charged. The droplet DL may be outputted in the direction of the axis CL, such as shown in FIG. 4 by the electrostatic force in the electric field generated between the electrode 88 and the target material at the outlet 86a.

Here, although the opening 88a may be formed in the electrode 88 as shown in FIG. 5, the electrode 88 may preferably act as an electrical conductor substantially rotationally symmetric about the axis CL passing through the center 88c. The potential gradient between the outlet 86a and the electrode 88 may preferably be substantially rotationally symmetric about the axis CL. With this configuration, when the center 88c of the electrode 88 lies on the axis CL, the droplet DL may be outputted in the direction of the axis CL. That is, even when the EUV light generation apparatus 1 is inclined with respect to the gravitational direction as shown in FIG. 2, the droplet DL may be outputted in the direction of the inclination angle of the EUV light generation apparatus 1 with respect to the gravitational direction.

As shown in FIG. 7B, while the target supply unit 8 is in operation, a period T1 in which a voltage is not applied between the electrode 83 and the electrode 88 and a period T2 in which a predetermined voltage is applied between the electrode 83 and the electrode 88 by the voltage generator 7 may be repeated alternately. In this case, during the period T1, substantially only the pressure by the inert gas may be applied on the target material inside the tank 81, and the target material may project through the outlet 86a, as shown in state Sb in FIG. 7A. The droplet DL may not be generated during the period T1. On the other hand, during the period T2, the pressure by the inert gas may be applied on the target material inside the tank 81 and the voltage may be applied between the electrode 83 and the electrode 88 by the voltage generator 7. Accordingly, the target material projecting through the outlet 86a may be separated from the outlet 86a by the electrostatic force and outputted as the droplet DL, as shown in state Sc in FIG. 7A. That is, the target supply unit 8 of the first embodiment may be configured such that the period T1 in which the target material projects through the outlet 86a and the period T2 in which the droplet DL is generated and outputted may be repeated alternately. Thus far, the operation of the target supply unit 8 when working properly has been described.

On the other hand, as stated above, when the EUV light generation apparatus is inclined with respect to the gravitational direction, there may be a case where the target material projecting through the outlet in the nozzle unit grows excessively large and drops in the gravitational direction, as shown by arrow G in FIG. 4. To counter this situation, the electrode 88 may preferably be positioned such that the opening 88a formed therein is located below the outlet 86a in the gravitational direction. With this arrangement, the target material that drops in the gravitational direction may pass through the opening 88a. That is, the electrode 88 may be positioned such that the target material that drops in the gravitational direction does not come into contact with the electrode 88. Accordingly, in the target supply unit 8 of the first embodiment, a possibility where the target material adheres onto the electrode 88 may be reduced. Thus, a possibility where the droplets DL are outputted stably may be increased.

### 3.3 Modifications

### 3.3.1 First Modification

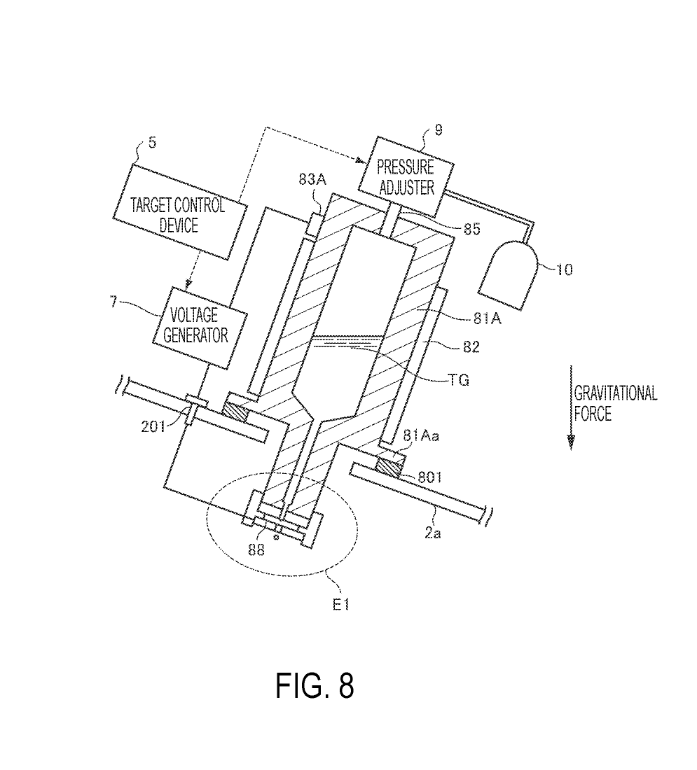

The tank 81 of the target supply unit 8 shown in FIG. 3 may be formed of an electrically conductive material instead of an electrically non-conductive material. FIG. 8 shows an example of the configuration of a target supply unit according to a modification of the first embodiment. As shown in FIG. 8, when a tank 81A is formed of an electrically conductive material, an electrode 83A may be attached on the outer wall of the tank 81A, and the electrode 83A may be connected to the voltage generator 7 through a conductive wire. With this arrangement, a predetermined potential may be applied to the target material TG inside the tank 81A without a conductive wire penetrating the tank 81A. Here, in this configuration, as shown in FIG. 8, an electrical insulator 801 may be interposed between a flange 81Aa of the tank 81A and the wall 2a of the chamber 2, as shown in FIG. 2, in order to provide electrical insulation between the tank 81A and the chamber 2. The electrical insulator 801 may, for example, be formed of ceramics, such as sintered aluminum oxide. The configuration and the operation of the other components depicted in FIG. 8 may be similar to those described with reference to FIG. 3.

### 3.3.2 Second Modification

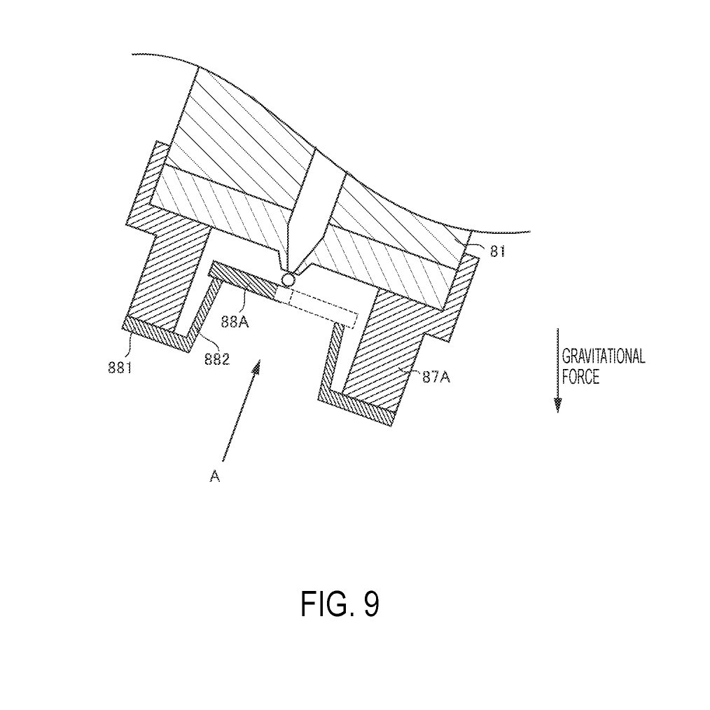

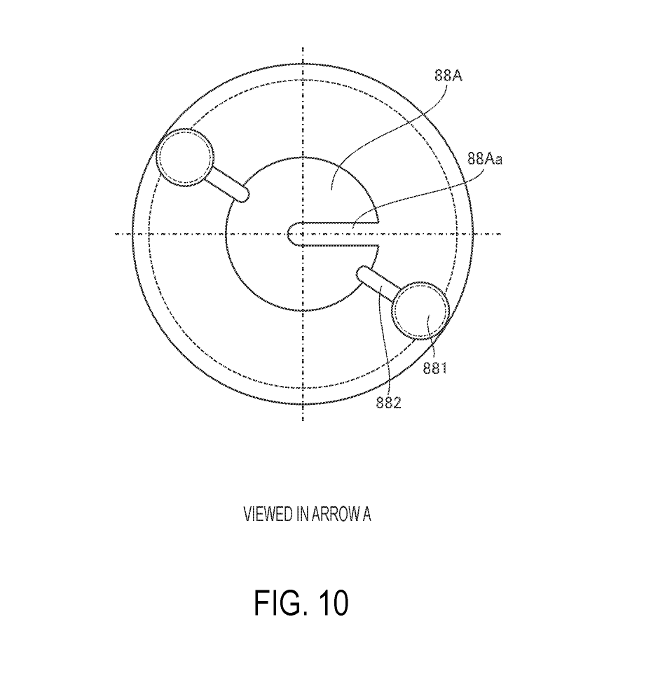

The configuration of the tip portion E1 of the target supply unit 8 of the first embodiment is not limited to the example shown in FIG. 4, and may be modified as shown in FIGS. 9 and 10. In the configuration shown in FIG. 4, the electrical insulator 87 interposed between the nozzle unit 86 and the electrode 88 may be relatively thin, and the voltage between the electrode 88 and the target material inside the nozzle unit 86 may be extremely high, for example, 20 kV. Accordingly, a dielectric breakdown due to a creeping discharge may occur on the surface of the electrical insulator 87. When the dielectric breakdown occurs on the electrical insulator 87, the electrostatic force between the target material inside the nozzle unit 86 and the electrode 88 may be not generated, and thus the droplet DL may not be generated. Accordingly, in the configuration shown in FIG. 9, an electrical insulator 87A may have such a shape that an insulating distance is secured to reduce a possibility of the occurrence of a dielectric breakdown by a creeping discharge. In the configuration shown in FIGS. 9 and 10, an electrode 88A may be attached to the electrical insulator 87A through a support 882 and an attachment 881. As in the electrode 88, the electrode 88A may be disc-shaped, and have an opening 88Aa that extends linearly from the center toward the periphery of the electrode 88A formed therein.

### 4. Target Supply Unit: Second Embodiment

When a distance between two successive droplets outputted toward a plasma generation region from a target supply unit is short, there may be a case where debris generated when one droplet is irradiated with a laser beam negatively affects a succeeding droplet. For example, debris generated from one droplet may collide with a succeeding droplet, and the direction in which the succeeding droplet travels may be deflected. Accordingly, EUV light may not be generated stably. Thus, in a second embodiment, a target supply unit may be provided with a second electrostatic pull-out mechanism. With this configuration, a droplet outputted from the target supply unit may be accelerated to increase a distance between two successive droplets.

### 4.1 Configuration

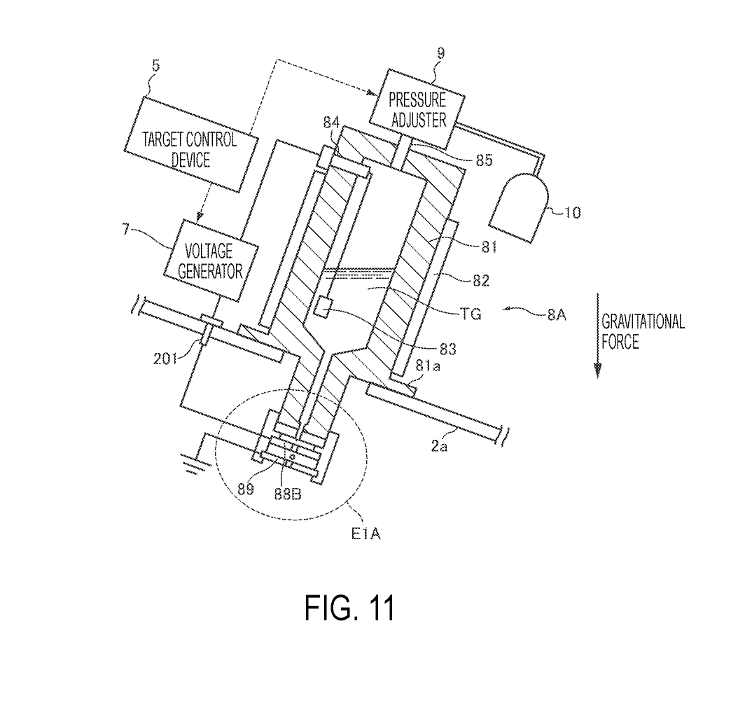

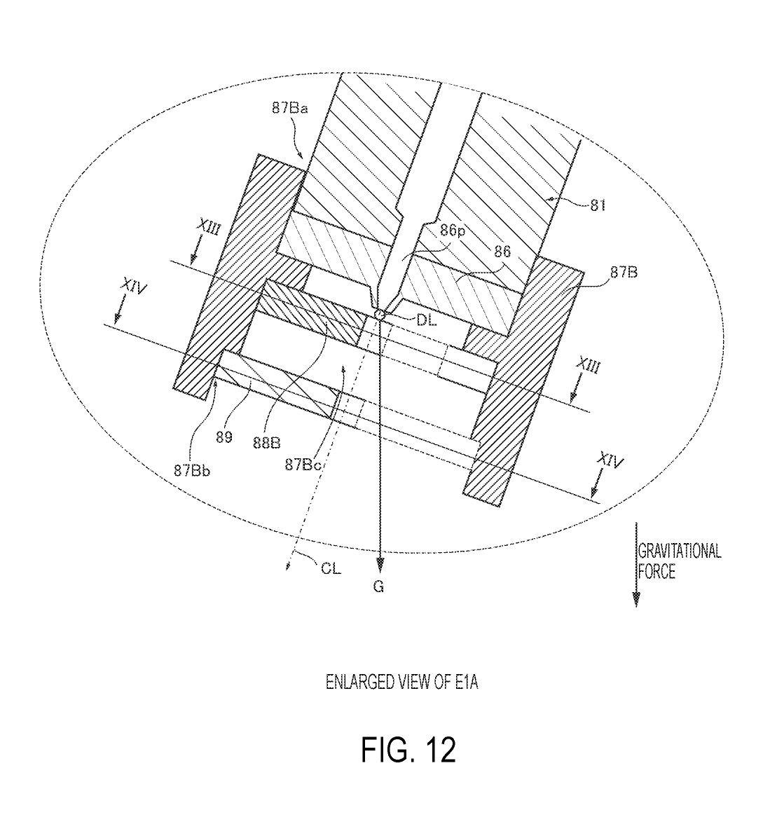

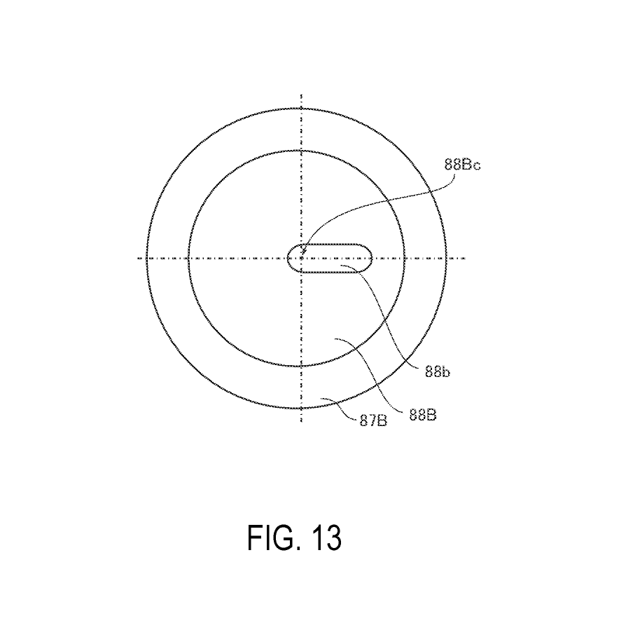

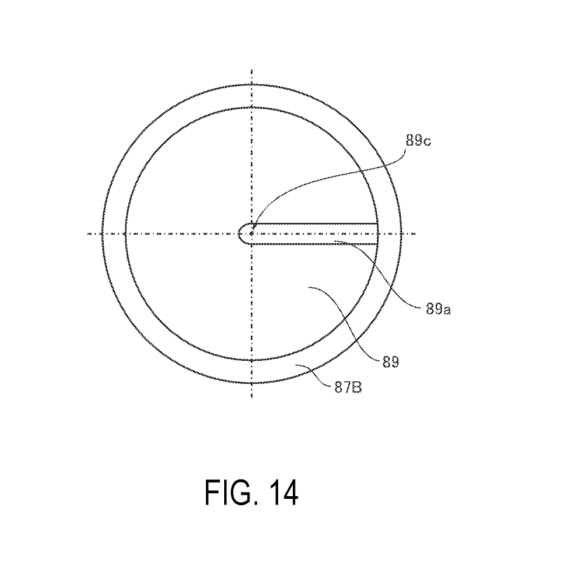

Hereinafter, an example of the configuration of a target supply unit according to the second embodiment will be described with reference to FIGS. 11 through 14. FIG. 11 schematically illustrates the example of the configuration of the target supply unit according to the second embodiment and the peripheral components thereof. FIG. 12 is a fragmentary enlarged view illustrating a leading end portion of the target supply unit shown in FIG. 11. FIG. 13 is a sectional view of the target supply unit shown in FIG. 12, taken along XIII-XIII plane. FIG. 14 is a sectional view of the target supply unit shown in FIG. 12, taken along XIV-XIV plane. In FIGS. 11 through 14, the components similar to those shown in FIG. 3 through 5 will be referenced by similar reference characters, and duplicate description thereof will be omitted.

As shown in FIGS. 11 and 12, in a target supply unit 8A, an electrode 89, serving as a second electrically conductive member, may be provided downstream from a first electrically conductive member, electrode 88B, which corresponds to the electrode 88 in the first embodiment, in the direction in which the droplet DL travels. The target supply unit 8A may include a second electrostatic pull-out mechanism to generate an electric field between the electrode 88B and the electrode 89 in order to accelerate the droplet DL through the electric field. A power supply (not shown) configured to apply a voltage between the electrode 88B and the electrode 89 to generate an electric field may be provided. Alternatively, as shown in FIG. 11, a voltage may be generated between the electrode 89 and the electrode 88B by grounding the electrode 89 and applying a potential other than the ground potential to the electrode 88B by the voltage generator 7.

As shown in FIGS. 12 through 14, a substantially cylindrical electrical insulator 87B may be provided at a leading end portion E1A of the target supply unit 8A. A recess 87Ba may be formed in one of the flat surfaces of the electrical insulator 87B, and recesses 87Bb and 87Bc each having a differing opening cross-section area may be formed continuously in the other flat surface of the electrical insulator 87B. The nozzle unit 86 and an end of the tank 81 may be sequentially fitted in the recess 87Ba, the electrode 88B may be fitted in the recess 87Bc, and the electrode 89 may be fitted in the recess 87Bb. With this arrangement, the nozzle unit 86 and the electrode 88B may face each other with a space secured therebetween. Further, the electrode 88B and the electrode 89 may face each other with a space secured therebetween. Each of the electrode 88B and the electrode 89 may include an electrically conductive material, such as molybdenum, and may be coated on its surface with an electrically non-conductive material, such as a ceramic.

As shown in FIGS. 12 through 14, each of the electrode 88B and the electrode 89 may be substantially disc-shaped, and be positioned along a plane perpendicular to a moving path of the droplet DL from the outlet 86a to the plasma generation region PG. Each of the electrode 88B and the electrode 89 may have an opening formed therein. That is, an opening 88b, serving as a first opening, may be formed in the electrode 88B as shown in FIG. 13, and an opening 89a, serving as a second opening, may be formed in the electrode 89 as shown in FIG. 14. As shown in FIGS. 12 through 14, the electrode 88B and the electrode 89 may be positioned such that a center 88Bc of the electrode 88B and a center 89c of the electrode 89 lie on the axis CL.

As one example of the opening 88b, the opening 88b that extends linearly from the center 88Bc toward the periphery of the electrode 88B may be formed in the electrode 88B. Similarly, the opening 89a that extends linearly from the center 89c toward the periphery of the electrode 89 may be formed in the electrode 89. Here, as in the shape shown in FIG. 6, as another example of each of the opening 88b and the opening 89a, a circular opening having a predetermined radius from the center 88Bc or the center 89c may further be provided.

### 4.2 Operation

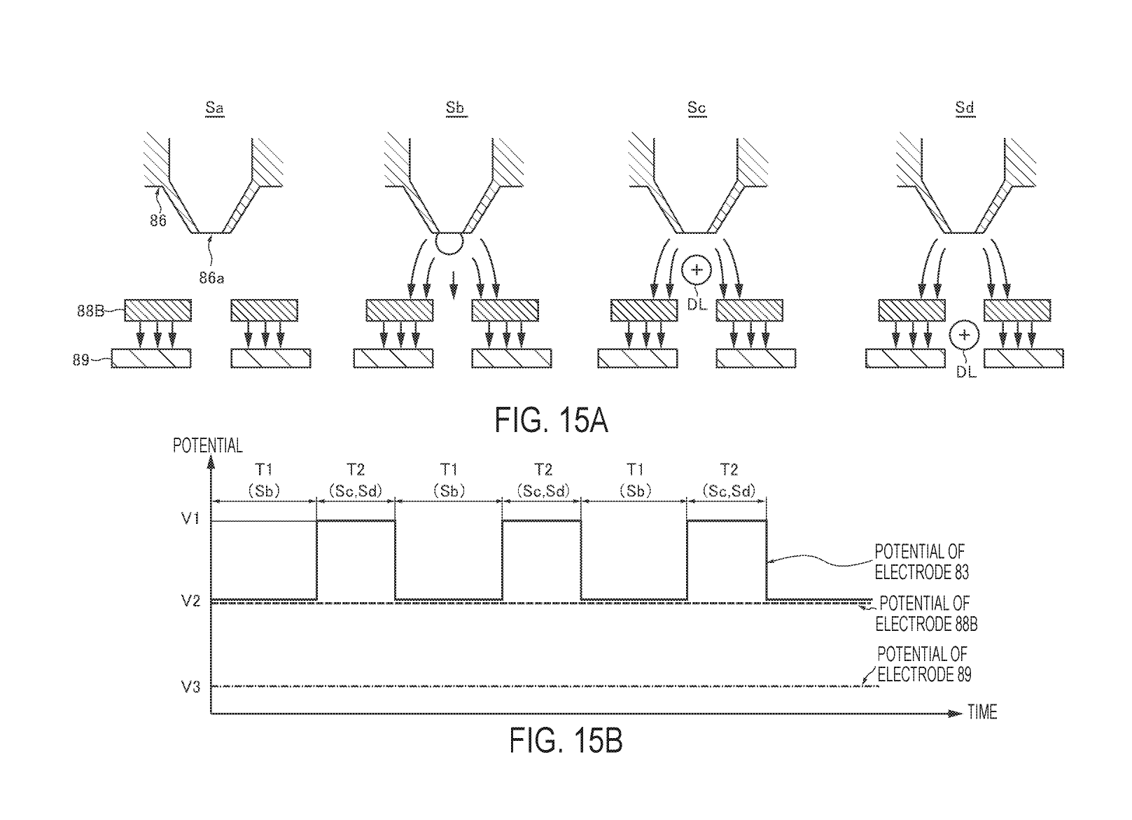

The operation of the target supply unit 8A will now be described with reference to FIGS. 11 through 15B. FIGS. 15A and 15B are diagrams for discussing a process through which a droplet of the target material is generated and accelerated. In the description to follow, primarily, the operation that differs from that of the target supply unit 8 according to the first embodiment will be described.

Before the target supply unit 8A is put in operation, a state Sa in FIG. 15A may correspond to the state Sa in FIG. 7A, and a state Sb in FIG. 15A may correspond to the state Sb in FIG. 7A. In the states Sa and Sb in FIG. 15A, a voltage may or may not be applied between the electrode 88B and the electrode 89 to generate an electric field therebetween.

Then, as in the first embodiment, when a potential applied to the electrode 88B is V2, the voltage generator 7 may vary a potential applied to the electrode 83 as V2→V1→V2→V1→ . . . (V1>V2). The electrode 89 may be set to a potential V3, such as the ground potential as shown in FIG. 11 that is lower than the potential V2. That is, the voltage generator 7 may intermittently apply a voltage (V1-V2) between the electrode 83 and the electrode 88B and retain a voltage (V2-V3) between the electrode 88B and the electrode 89. When the voltage (V1-V2) is applied between the electrode 83 and the electrode 88B in the state Sb in FIG. 15A, the target material projecting through the outlet 86a may be separated by the electrostatic force and outputted as the droplet DL, as shown in state Sc in FIG. 15A. Here, the droplet DL may be positively charged. The droplet DL may be outputted in the direction of the axis CL, as shown in FIG. 12, by the electrostatic force in the electric field generated when the voltage (V1-V2) is applied between the electrode 83 and the electrode 88B. The droplet DL may pass through the opening 88b and be accelerated in the direction of the axis CL by the electrostatic force in the electric field generated when the voltage (V2-V3) is applied between the electrode 88B and the electrode 89, as shown in state Sd in FIG. 15A.

With reference to FIG. 15B, while the target supply unit 8A is put in operation, a period T1 in which a voltage is not applied between the electrode 83 and the electrode 88B and a period T2 in which a predetermined voltage is applied between the electrode 83 and the electrode 88B may be repeated alternately. In this case, substantially only a pressure may be applied on the target material during the period T1, and the target material may project through the outlet 86a, as shown in state Sb in FIG. 15A. On the other hand, a pressure may be applied on the target material and a voltage may be applied between the electrode 83 and the electrode 88B during the period T2. Accordingly, the target material projecting through the outlet 86a may be separated from the outlet 86a by the electrostatic force and outputted as the droplet DL, as shown in state Sc in FIG. 15A. Further, the droplet DL may be accelerated by the electrostatic force in the electric field generated when a voltage is applied between the electrode 88B and the electrode 89, as shown in state Sd in FIG. 15A. That is, the target supply unit 8A may be configured such that the period T1, as shown in state Sb in FIG. 15A, and the period T2, as shown in states Sc and Sd in FIG. 15A, are repeated alternately. Thus far, the operation of the target supply unit 8A when working properly has been described.

On the other hand, as stated above, there may be a case where a target material projecting through an outlet formed in a nozzle unit grows excessively large and drops in the gravitational direction, such as the direction shown by the arrow G in FIG. 12. When an EUV light generation apparatus is inclined with respect to the gravitational direction, the electrode 88B may preferably be positioned such that the opening 88b formed therein is located below the outlet 86a in the gravitational direction. Accordingly, the target material that drops in the gravitational direction may pass through the opening 88b. Further, the electrode 89 may preferably be positioned such that the opening 89a formed therein is located below the outlet 86a in the gravitational direction. Accordingly, the target material that has passed through the opening 88b may pass through the opening 89a. That is, the electrode 88B and the electrode 89 may be positioned such that the target material that drops in the gravitational direction does not come into contact with the electrode 88B and the electrode 89. Accordingly, in the target supply unit 8A of the second embodiment, a possibility where the target material adheres onto the electrode 88B and the electrode 89 may be reduced, and thus a possibility where the droplets DL are outputted stably and accelerated sufficiently may be increased.

The above-described embodiments and modifications thereof are merely examples for implementing this disclosure, and this disclosure is not limited thereto. Making various modifications according to the specifications or the like is within the scope of this disclosure, and other various embodiments are possible within the scope of this disclosure. The modifications illustrated for particular ones of the embodiments can be applied to other embodiments as well, including the other embodiments described herein. For example, in the above-described embodiments, the electrode(s) provided so as to face the nozzle unit 86 is/are substantially disc-shape, and provided along a plane perpendicular to the moving path of the target material from the outlet 86a to the plasma generation region PG. However, this disclosure is not limited thereto. A shape of the electrode(s) may be set such that the electrostatic force in a predetermined direction acts on the target material to guide the target material to the plasma generation region set at an arbitrary position inside the chamber. Such a predetermined direction need not be coaxial with the moving path of the target material. Regardless of the shape of the electrode(s), an opening formed therein may be set such that the target material that drops from the nozzle unit in the gravitational direction does not come into contact with the electrode(s). That is, the opening of the electrode(s) may be formed such that the target material that drops from the nozzle unit in the gravitational direction passes through the opening with a space therebetween.

The terms used in this specification and the appended claims should be interpreted as “non-limiting.” For example, the terms “include” and “be included” should be interpreted as “including the stated elements but not limited to the stated elements.” The term “have” should be interpreted as “having the stated elements but not limited to the stated elements.” Further, the modifier “one (a/an)” should be interpreted as at least one or “one or more.”

What is claimed is:

1. A target supply unit, comprising:
a nozzle through which a target material is outputted;
a first electrically conductive member having a first opening formed therein and positioned to face the nozzle in a direction into which the target material is outputted through the nozzle, the first electrically conductive member being positioned so that the first opening is located below the nozzle in a gravitational direction; and
a voltage generator configured to apply a voltage between the target material and the first electrically conductive member.

2. The target supply unit according to claim 1, further comprising a second electrically conductive member having a second opening formed therein and positioned to face the nozzle in the direction into which the target material is outputted through the nozzle, wherein:
the voltage generator is configured to apply a voltage between the first electrically conductive member and the second electrically conductive member, and
the second electrically conductive member is positioned so that the second opening is located below the nozzle in the gravitational direction.

3. The target supply unit according to claim 2, wherein:
the first electrically conductive member is planar and disc-shaped, and
the first opening is formed so as to extend from a center toward a periphery of the first electrically conductive member.

4. The target supply unit according to claim 3, wherein:
the second electrically conductive member is planar and disc-shaped, and
the second opening is formed so as to extend from a center toward a periphery of the second electrically conductive member.

5. An apparatus for generating extreme ultraviolet light, the apparatus comprising:
a chamber;
the target supply unit of claim 1;
a focusing optical system configured to direct an externally-applied pulse laser beam to a predetermined position inside the chamber; and
a collector mirror configured to collect and output the extreme ultraviolet light generated inside the chamber.
